(19) United States
(12) Patent Application Publication
(10) Pub. No.: US 2017/0270357 A1
(43) Pub. Date: Sep. 21, 2017

(54) HANDWRITTEN AUTO-COMPLETION

(71) Applicant: Microsoft Technology Licensing, LLC, Redmond, WA (US)

(72) Inventors: Amil Winebrand, Petach-Tikva (IL); Uri Ron, Kfar-Saba (IL); Zohar Nagola, Tel-Aviv (IL)

(21) Appl. No.: 15/069,993

(22) Filed: Mar. 15, 2016

(51) Int. Cl. G06K 9/00; G06F 3/0488; G06F 3/0354; G06F 3/01

(52) U.S. Cl. CPC G06K 9/00416; G06F 3/017; G06F 3/04883; G06F 3/03545

(57) ABSTRACT

A method includes tracking handwritten letter input with a human interface device, inking the handwritten letter input, identifying the letters and displaying at least one suggested word in-line with the inking. The suggested word is based on the letters identified.

### BACKGROUND

Auto-completion and predictive text algorithms are used in virtual keyboard and handwriting recognition applications. These algorithms are particularly useful in applications running on portable human interface devices (HID) typically limited in size. In virtual keyboard applications, auto-completion and predictive text algorithms help overcome ambiguity in identifying selected keys when the keys are small, speed up human-computer interaction and provide a more efficient use of fewer device keys to input writing into a text message, an e-mail, an address book, and a calendar.

With the adoption of active pen technologies, handwriting recognition applications, specifically on-line recognition applications, provide an alternative to virtual keyboards. Handwriting recognition applications operate by displaying a window for receiving the handwritten ink. The window displays the handwritten ink while the application converts the ink into letter codes. Auto-completion or predictive text algorithm suggests words or text based on the letter codes and typically displays the words in the window in text format. The converted or suggested text once approved by the user is displayed in a separate window associated with a word-processing application, e.g. a text message, an e-mail, an address book, a calendar, and the like.

Active pens are signal emitting pens that may be used with pen enabled HID. Position of the pen is tracked by picking up a signal emitted by the active pen with a digitizer sensor integrated on the HID. The pen may include memory capability for storing an identification code. The identification code may be transmitted to the HID during interaction. Active pens typically provide more accurate inking as compared to inking achieved by finger touch or passive pen interaction. Passive pens refer to pens that do not transmit a signal but interact with the digitizer sensor based on capacitive coupling. Passive pens are typically required to have a wider tip than active pens to enhance the capacitive coupling effect and may be less comfortable for inking handwritten text. Active pens operate with a tip that may be comparable in size to a ballpoint pen and therefore may be more convenient for inking. With the adoption of active pen technologies, interacting with an HID based on inking has become more convenient.

### SUMMARY

According to an aspect of some exemplary embodiments, a graphical user interface for a handwriting recognition application provides for displaying suggested auto-completion words or predictive text along a same line as the inking or in a same area used for inking. Optionally, the suggested auto-completion words or predictive text are also displayed in a same handwriting as the handwriting used for inking. At times users may prefer to maintain their notes in their own handwriting as opposed to converting their inking to digital text. At the same time, auto-completion or predictive text may be useful in speeding up the inking process and correcting typographical errors or misspellings. A user's experience during inking may be enhanced by also displaying the suggested words in the same handwriting as the inking.

According to some exemplary embodiments, the handwriting characteristics are stored in memory in association with an identification code of the active pen. Optionally, a personal dictionary of the user is also stored in association with the active pen. Alternatively or additionally, the handwriting characteristics and dictionary may be stored in association with a particular user. This may be useful when providing handwritten input with a finger or passive pen. In some exemplary embodiments, the handwriting characteristics, e.g. font and dictionary may be uploaded once the identification code or user is recognized by the HID.

Unless otherwise defined, all technical and/or scientific terms used herein have the same meaning as commonly understood by one of ordinary skill in the art. Although methods and materials similar or equivalent to those described herein can be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the disclosure are herein described, by way of example only, with reference to the accompanying drawings. With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

In the drawings:

FIG. 1 is an exemplary schematic drawing of a known GUI for a handwriting recognition application;

FIG. 2 is an exemplary schematic drawing of a GUI for a handwriting recognition application in accordance with some exemplary embodiments of the present disclosure;

FIGS. 3A and 3B are exemplary schematic drawings of a GUI for handwriting recognition application during and after selection of auto-complete words in accordance with some exemplary embodiments of the present disclosure;

FIG. 4 is a simplified flow chart of an exemplary method for applying auto-completion or predictive text to handwritten input in accordance with some exemplary embodiments of the present disclosure; and

FIG. 5 is a simplified schematic drawing of an active pen and an HID in accordance with some exemplary embodiments of the present disclosure.

### DETAILED DESCRIPTION

According to some exemplary embodiments, there is provided a graphical user interface (GUI) for a handwriting recognition application that displays both handwritten strokes and words suggested by an auto-complete or predictive text algorithm in user's own handwriting. According to some exemplary embodiments, auto-complete words and predictive text are integrated in an area in which the user is inking. Optionally, at least one auto-complete suggested word is displayed on a same line as the inking so as to visual complete the word being inked by the user. Others suggestions may be listed above or below the suggestion positioned on the same line as the inking. Optionally, a list of auto-complete suggestions are displayed as a column adjacent the most recent inking. The auto-complete suggested word may be displayed in a different color.

According to some exemplary embodiments, while a user is inking, a handwriting recognition algorithm converts the inking to digital text. An auto-complete algorithm or a predictive text algorithm receives the digital text and displays suggestions for completing the word or text in the user's own handwriting and at the location that the user is inking. The user may select the desired word by performing a gesture at the location of inking. Optionally, the gesture may be swipe or a tap.

Optionally, the user may select a word by pointing to it and pressing a selection button on the active pen, scrolling a capacitive button or scroll wheel on the pen barrel, or even rotating/tilting the pen. The latter actions would traverse through the options presented on screen. The word or text once selected is added to the user's inking in the same handwriting as the handwriting of the user. Optionally, the GUI may also be used for inking with a finger or a passive pen.

According to some exemplary embodiments, a personal font and optionally a personal dictionary is stored in memory in the HID or in remote memory, e.g. cloud memory in association with an identification code provided by the active pen. Alternatively, the personal font or dictionary may be stored in memory included or fetched by the active pen. Typically, the handwriting recognition program learns the personal font as the user inks with the active pen. Optionally, authentication of the user operating the active pen is required prior to displaying recognized inking in the personal font.

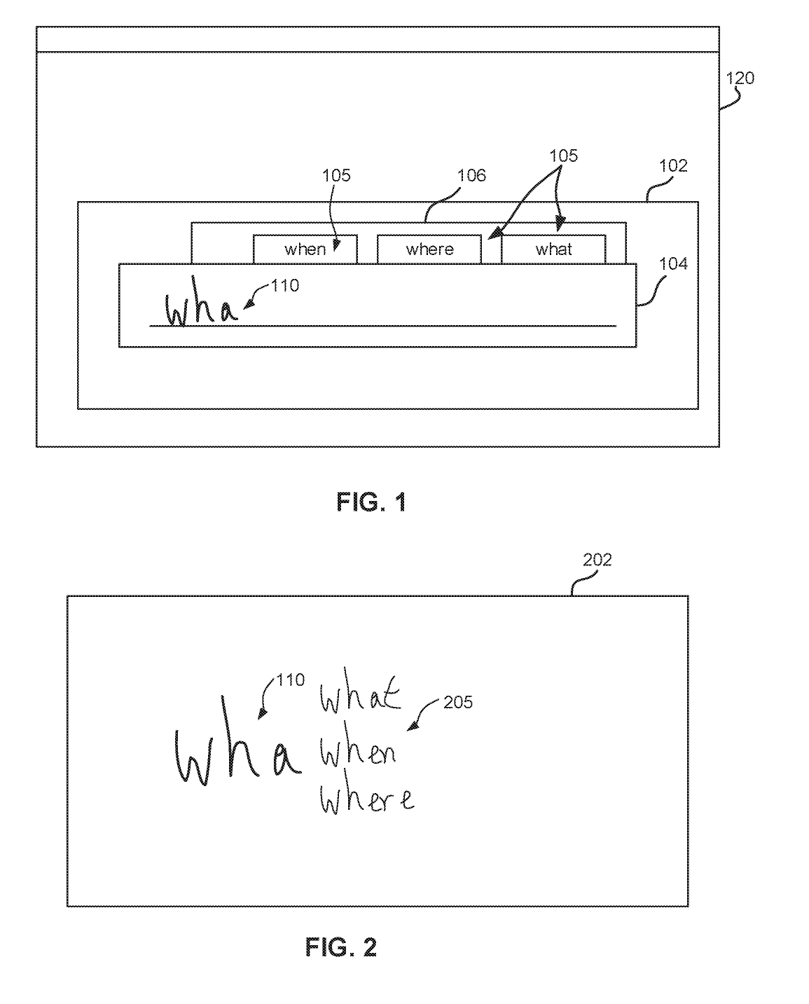

FIG. 1 is an exemplary schematic drawing of a known GUI for a handwriting recognition application. Known handwriting recognition applications typically have a dedicated window 102 in which the inking 110 is displayed. The inking is converted to text codes and based on the text codes, the application displays suggested words 105 in digital text format. Suggested words 105 are typically displayed in a dedicated sub-window 106 that is displaced from a sub-window 104 in which the inking is displayed. A user is required to lift the active pen (or finger) and select by touch one of the suggested options. Once a selection is made inking 110 is erased from window 104 and appears instead in digital text format in a word processing application running in a separate window 120.

Reference is now made to FIG. 2 showing an exemplary schematic drawing of a GUI for a handwriting recognition application in accordance with some exemplary embodiments of the present disclosure. According to some exemplary embodiments, a handwriting recognition application runs in a window 202. A user provides strokes displayed with ink 110. As the user provides the strokes, the application recognizes the strokes, converts them to text codes and suggests words 205 to complete the handwritten ink 110. In some exemplary embodiments, suggested words 205 may be displayed alongside a current location of the handwritten ink 110. Optionally, the list of words 205 may be displayed in a column alongside handwritten ink 110. Words 205 may be displayed in a color other than handwritten ink 110 or using the same color but with a finer line width.

Words 205 suggested by the application are displayed with a personal font that mimics the user's handwriting. The personal font may be font that the application learns over time or over one or more dedicated calibration session. Methods for creating a personal font based on handwritten examples are known. The words suggested may be based on a dictionary or personal dictionary that the application accumulates over time or based on scanning words in documents stored in the HID device. Optionally, the order of the words suggested may be listed based on their likehood for being the correct word.

In some exemplary embodiments, window 202 is a window on which a word processing application is running and the handwritten ink 110 is maintained and stored. The handwritten ink 110 may optionally be converted to the personal font prior to being stored.

Alternatively, window 202 may be a dedicated window for handwriting recognition and words that are recognized will appear instead in a word processing application running in a separate window. The words in the separate word processing window may appear in the personal font or in the digital font.

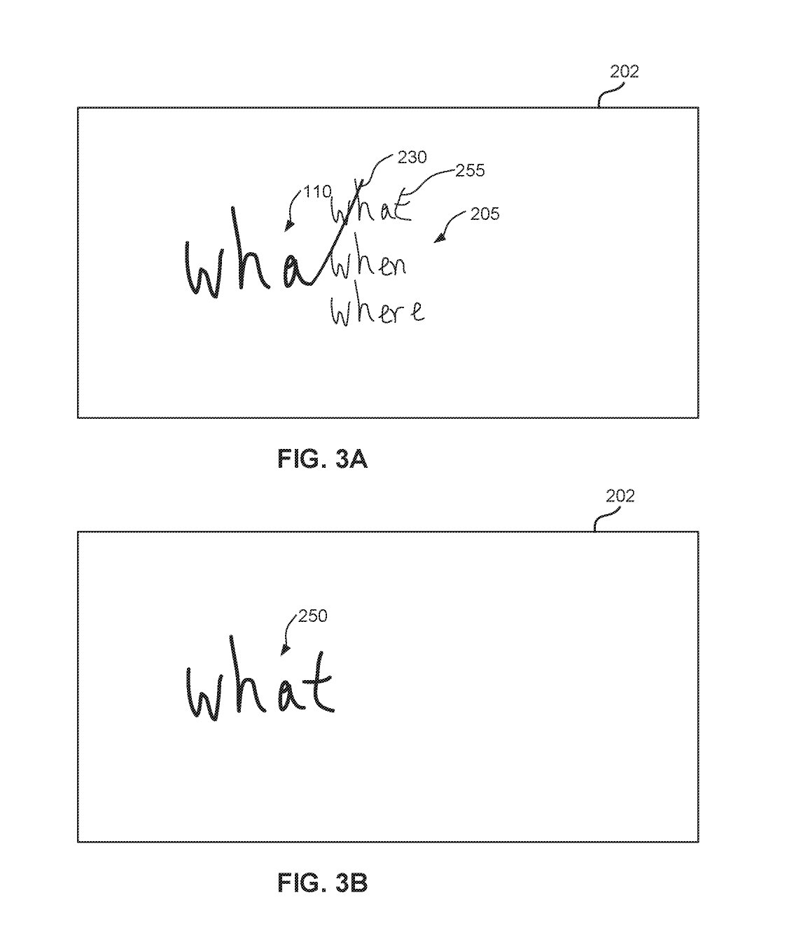

Reference is now made to FIGS. 3A and 3B showing an exemplary schematic drawings of a GUI for handwriting recognition application during and after selection of auto-complete words in accordance with some exemplary embodiments of the present disclosure. In some exemplary embodiments, a user may select one of suggested words 205 with a stroke 230 that sweeps across selected word 255 or by tapping on word 255. Since words 205 are positioned alongside handwritten ink 110, the selection may be made quickly and intuitively. In other exemplary embodiments, the selection may be by pointing at word 255 or by pressing a button on the active pen while pointing. Optionally, a button on the active pen toggles between suggestions that are displayed on window 202. Optionally, one of the selections is a blank in case the user wants to reject all suggestions. Optionally, the user may select a word by pointing to it and pressing a selection button on the active pen, scrolling a capacitive button or scroll wheel on the pen barrel, or even rotating/tilting the pen. The latter actions would traverse through the options presented on screen.

Optionally, at least one of the suggested words is positioned along a same line as that handwritten ink 110. Typically, the word positioned along a same line as handwritten ink 110 is the word associated with the highest probability of being the word intended by the user. Optionally, selection of that word is achieved by the user continuing the inking. Optionally, the words are arranged so that the words associated with a greater probability are positioned closer to the line (the virtual line) on which the inking is provided. Once selected, word 250 is displayed in the personal font defined for a particular user or for a particular active pen providing the input (FIG. 3B).

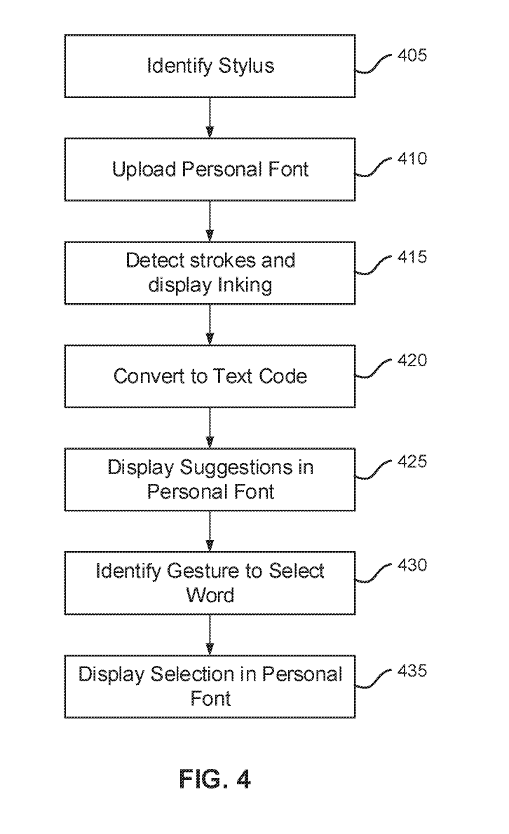

Reference is now made to FIG. 4 showing a simplified flow chart of an exemplary method for applying auto-completion or predictive text to handwritten input in accordance with some exemplary embodiments of the present disclosure. In some exemplary embodiments, an active pen interacting with an HID is identified (block 405). Typically, identification is based on an identification code transmitted by the active pen. According to some exemplary, a personal font associated with the active pen identification is uploaded from memory (block 410). Memory may be integrated in HID or may be remote memory that is fetched by either the active pen or the HID. Optionally, a personal font associated with the identification information is uploaded or activated based on identification information provided by a user with or without the active pen. As the user provides strokes with the active pen, the strokes are detected and inking is displayed (block 415). The strokes are converted to text code that can be used by an auto-completion or predictive text algorithm (block 420). As the user is providing the strokes, an auto-completion or predictive text algorithm displays suggestions in the personal font (block 425). The user performs a pre-defined gesture to select one of the suggestions or reject all suggestions. The gesture is recognized (block 425) and the selection is displayed in the personal font (block 430).

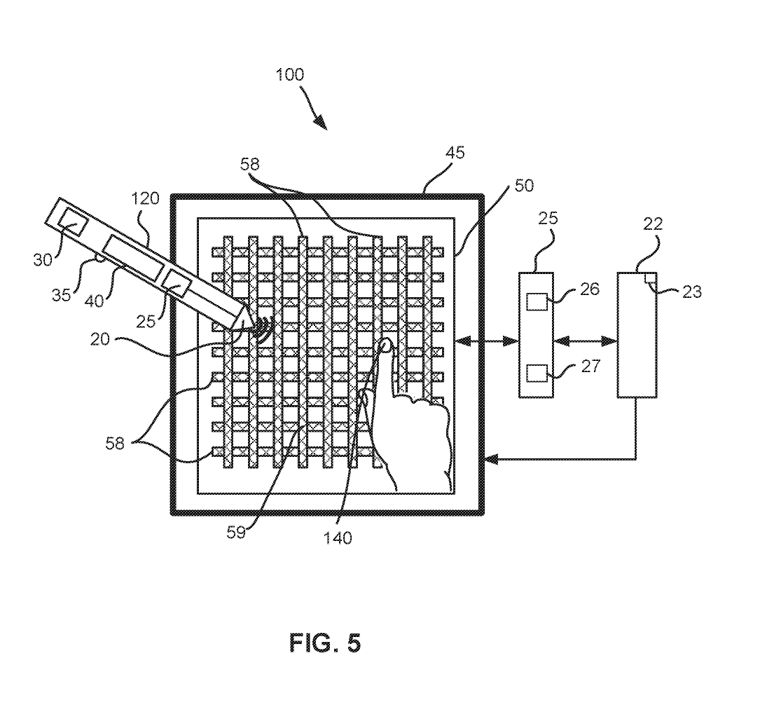

Reference is now made to FIG. 5 showing a simplified schematic drawing of an active pen and an HID in accordance with some exemplary embodiments of the present disclosure. According to some embodiments of the present disclosure, an HID 100 includes a display 45 that is integrated with a digitizer sensor 50. In some exemplary embodiments, digitizer sensor 50 is a grid based capacitive sensor formed with row and column conductive strips 58 forming grid lines. Typically, conductive strips 58 are electrically insulated from one another and each of conductive strips is connected at least at on one end to circuit 25, e.g. touch controller. Capacitive coupling formed between the row and column conductive strips is sensitive to presence of conductive and dielectric objects. Alternatively, digitizer sensor 50 may be formed with a matrix of electrode junctions that is not necessarily constructed based on row and column conductive strips.

According to some embodiments of the present disclosure, conductive strips 58 are operative to detect touch of one or more fingertips 140 or other conductive objects as well as input by an active pen 120 transmitting an electromagnetic signal typically via the writing tip 20 of active pen 120. Typically, output from both row and column conductive strips 58, e.g. from two perpendicular axes are sampled to detect coordinates of active pen 120. In some exemplary embodiments, circuit 25 typically includes an active pen detection engine 27 for synchronizing sampling windows with transmission times of active pen 120, for processing input received by active pen 120, for tracking coordinates of active pen 120, for receiving an identity code of the active pen and/or for tracking pen-up (touch) and pen-down (hover) events. In some exemplary embodiments, active pen 120 includes a pressure sensor 25 associated with tip 20 for sensing pressure applied on tip 20. Inking is typically based on strokes performed will the active pen is reporting a pen-down state.

Input transmitted by active pen 120 may include identification, pressure as well as other information directly related to active pen 120, related to an environment around the active pen 120, to a user using active pen 120, to privileges allotted to the active pen 120, capabilities of active pen 120, or information received from a third party device. Optionally, active pen 120 transmits data defining a personal font or a personal dictionary associated with a user using active pen 120. Additional information related to the active pen may include indications of a pressed button(s) 35, tilt, identification, manufacturer, version, media access control (MAC) address, and stored configurations such as color, tip type, brush, and add-ons.

Typically, active pen 120 includes an ASIC 40 that controls generation of a signal emitted by active pen 120. ASIC 40 typically encodes information generated, stored or sensed by active pen 120 on the signal transmitted by active pen 120. Typically, active pen detection engine 27 decodes information received from active pen 120. According to some exemplary embodiments, active pen 120 additionally includes a wireless communication unit 30, e.g. an auxiliary channel with Bluetooth communication, near field communication (NFC), radio frequency (RF) communication using module 23 of host 22. Information between active pen 120 and HID 100 may be transmitted between wireless communication unit 30 and module 23.

Circuit 25, e.g. touch controller may apply mutual capacitance detection or a self-capacitance for sensing a capacitive effect due to touch (or hover) of fingertip 140. Circuit 25 typically includes finger detection engine 26 for managing a triggering signal for mutual capacitive detection, for processing the touch signal and for tracking coordinates of one or more fingertips 140.

Typically, output from circuit 25 is reported to host 22. Typically, the output provided by circuit 25 may include coordinates of one or more fingertips 140, coordinates of writing tip 20 of active pen 120, a pen-up or pen-down status of tip 20, identity and additional information provided by active pen 120, e.g. pressure, tilt, and battery level. Host 22 may transmit the information to an application manager or a relevant application. Optionally, circuit 25 and host 22 may transfer the raw information to an application. The raw information may be analyzed or used as needed by the application. At least one of active pen 120, circuit 25 and host 22 may pass on the raw information without analysis or being aware of the information.

According to some aspects of the present disclosure there is provided a method comprising: tracking handwritten letter input with a human interface device; inking the handwritten letter input; identifying the letters; and displaying at least one suggested word in-line with the inking, wherein the at least one suggested word is based on the letters identified.

Optionally, the method includes displaying a plurality of suggested words in a column, wherein the column is displayed alongside a current location of the inking.

Optionally, the method includes selecting one of the plurality of suggested words based on detecting a stroke extending across the one suggested word.

Optionally, the inking is provided with an active pen including a selection button and wherein selecting one of the plurality of suggested words is based on detecting activation of the button over the one suggested word.

Optionally, the button is a capacitive button or scroll wheel and wherein the button or scroll wheel is configured to traverse through the options presented on screen.

Optionally, the inking is provided with an active pen button and wherein selecting one of the plurality of suggested words is based on rotating or tilting the pen.

Optionally, the suggested word associated with a highest probability of being the word intended by the user providing the handwritten ink is the word displayed in-line with the inking.

Optionally, the method includes displaying the at least one suggested word in a font that is defined to resemble the inking of the hand written letter input.

Optionally, the font is defined from the inking detected over time based on a learning process.

Optionally, inking is based on input provided by an active pen, wherein the input includes an identity code and wherein the font is associated with the identity code.

Optionally, inking is based on input provided by an active pen, wherein the input includes an identity code and wherein the at least one suggested word is selected from a dictionary associated with the identity code.

Optionally, the at least one suggested word is displayed in a color or shade that is other than the color or shade of the inking.

Optionally, the handwritten letter input is provided with fingertip or with a passive pen.

According to an aspect of some exemplary embodiments there is provided graphical user interface comprising: a window displaying inking based on handwritten letter input; and at least one suggested word displayed in-line with the inking, wherein the at least one suggested word is based on identifying the handwritten letter input and output from an auto-completion or text prediction algorithm.

Optionally, the at least one suggested word is displayed in a font that is defined to resemble the inking of the hand written letter input.

Optionally, the font is uploaded based on identifying a user or identifying an active pen providing the inking.

Optionally, the graphical user interface includes a plurality of suggested words displayed in a column alongside a current location of the inking.

Optionally, the at least one suggested word associated with a highest probability of being the word intended by the user providing the inking is the word displayed in-line with the inking.

Optionally, the at least one suggested word displayed in-line with the inking changes in response to receiving input from a stylus.

Optionally, the at least one suggested word is displayed in a color or shade that is other than the color or shade of the inking.

Certain features of the examples described herein, which are, for clarity, described in the context of separate embodiments, may also be provided in combination in a single embodiment. Conversely, various features of the examples described herein, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

What is claimed is:

1. A method comprising:
tracking handwritten letter input with a human interface device;
inking the handwritten letter input;
identifying the letters; and
displaying at least one suggested word in-line with the inking, wherein the at least one suggested word is based on the letters identified.

2. The method of claim 1, comprising displaying a plurality of suggested words in a column, wherein the column is displayed alongside a current location of the inking.

3. The method claim 2, comprising selecting one of the plurality of suggested words based on detecting a stroke extending across the one suggested word.

4. The method of claim 2, wherein the inking is provided with an active pen including a selection button and wherein selecting one of the plurality of suggested words is based on detecting activation of the button over the one suggested word.

5. The method of claim 4, wherein the button is a capacitive button or scroll wheel and wherein the button or scroll wheel is configured to traverse through the options presented on screen.

6. The method of claim 2, wherein the inking is provided with an active pen button and wherein selecting one of the plurality of suggested words is based on rotating or tilting the pen.

7. The method of claim 1, wherein the suggested word associated with a highest probability of being the word intended by the user providing the handwritten ink is the word displayed in-line with the inking.

8. The method of claim 1, comprising displaying the at least one suggested word in a font that is defined to resemble the inking of the hand written letter input.

9. The method of claim 8, wherein the font is defined from the inking detected over time based on a learning process.

10. The method of claim 8, wherein inking is based on input provided by an active pen, wherein the input includes an identity code and wherein the font is associated with the identity code.

11. The method of claim 8, wherein inking is based on input provided by an active pen, wherein the input includes an identity code and wherein the at least one suggested word is selected from a dictionary associated with the identity code.

12. The method of claim 1, wherein the at least one suggested word is displayed in a color or shade that is other than the color or shade of the inking.

13. The method of claim 1, wherein the handwritten letter input is provided with fingertip or with a passive pen.

14. A graphical user interface comprising:
a window displaying inking based on handwritten letter input; and
at least one suggested word displayed in-line with the inking, wherein the at least one suggested word is based on identifying the handwritten letter input and output from an auto-completion or text prediction algorithm.

15. The graphical user interface of claim 14, wherein the at least one suggested word is displayed in a font that is defined to resemble the inking of the hand written letter input.

16. The graphical user interface of claim 15, wherein the font is uploaded based on identifying a user or identifying an active pen providing the inking.

17. The graphical user interface of claim 14, comprising a plurality of suggested words displayed in a column alongside a current location of the inking.

18. The graphical user interface of claim 14, wherein the at least one suggested word associated with a highest probability of being the word intended by the user providing the inking is the word displayed in-line with the inking.

19. The graphical user interface of claim 14, wherein the at least one suggested word displayed in-line with the inking changes in response to receiving input from a stylus.

20. The graphical user interface of claim 14, wherein the at least one suggested word is displayed in a color or shade that is other than the color or shade of the inking.
